(19) United States
(12) Patent Application Publication
(10) Pub. No.: US 2002/0091936 A1
(43) Pub. Date: Jul. 11, 2002

(54) Method of monitoring multi-media communication between parties

(76) Inventor: Julia Tema, Shelton, CT (US)

Correspondence Address: Ward & Olivo, Suite 300, 382 Springfield Avenue, Summit, NJ, 07901, US

(21) Appl. No.: 09/755,010

(22) Filed: Jan. 5, 2001

(51) Int. Cl. H04L 9/32

(52) U.S. Cl. 713/200

(57) ABSTRACT

A method of monitoring multi-media communication between parties, wherein a user logs onto a primary safe room and upon authentication may enter additional branch rooms for various activities. Such monitoring allows for a child to safely explore the Internet and other related media with the assistance of an off-site buddy technician.

### FIELD OF THE INVENTION

The present invention relates to communication devices and specifically involves regulated Internet communication between one or more parties.

### BACKGROUND OF THE INVENTION

By 2005, 44 million American children will surf the Internet regularly. This is a staggering number, and it gets larger every year. Unfortunately, every one of these 44 million children is a potential young victim for the many predators online. Daily newspapers around the country are constantly peppered with stories of adults who used the Internet to lure children to offline meetings. The results are always horrific. New pornography and adult-oriented Internet sites are launched every week, and many of these provide free, instant access without age verification. Essentially, for every opportunity a child has on the Internet, there is a potential danger. The only way to divert children from the perils of the Internet and ensure their safety is to provide them with the proper education, supervision and Internet outlets.

The requisite education and supervision would ideally be supplied by parents. However, as the number of children using the Internet rises, so does the number of single-parent and dual-income households. Thus, many parents do not have the time or energy to properly educate their children about the Internet. Of those who do, very few supervise and direct their child's activities for the duration of time the child is online.

Internet-wide regulations aimed at child safety could help compensate for the lack of parental supervision. Unfortunately, it is unlikely that all branches of the government will agree on such extensive, far-reaching legislation in the near future. For example, in 1996, Congress approved the Communications Decency Act, which would have made it illegal to distribute obscene or indecent material over the Internet. The Supreme Court overturned the Act, ruling that its language was too vague to comport with the First Amendment. A few years later, President Clinton assembled the Internet Online Summit, which brought together hundreds of media, education and government leaders. After several months of debate, the group still had not reached consensus on how to make the entire Internet a safer place for children.

With parents indisposed and the government unsure about what to do, it appears that the only way to truly protect children from the terrors of the Internet is to create a safe and secure place for them within it—a space where they can receive an education, supervision and have access to safe Internet outlets from underneath one electronic roof.

There are already a variety of Internet locations and software programs designed specifically to promote child safety. The sites usually include information such as Internet safety tips, educational quizzes and tutoring chat rooms where students can receive help with homework. However, they are all deficient in at least one respect.

Disney's Surf Swell Island web site, for example, is designed to instruct children on how to navigate the Internet safely. This site comprises a variety of Internet safety activities for children, including an information tutorial and quizzes which test the child's understanding of Internet safety and proper Internet conduct. Upon answering questions correctly, the child is awarded a digital “Internet Safety Certificate” which may serve as indication to parents that their children understand how to use the Internet responsibly. This certificate, however, does not guarantee a child's safety on the Internet; many adult and hate web sites can be accidentally accessed through search engines despite the user's intended search. Additionally, this web site does not provide children with the ability to have real-time correspondence with another child, and it cannot monitor a child's activities.

Existing tutoring locations also have their limitations. For example, America Online's tutoring rooms limit a child to three questions. Children are also forced to exit the service after fifteen minutes, and cannot reenter for at least an hour. Thus, on America Online's service, children are unable to communicate for extended periods of time with a guaranteed safe educational source. Additionally, these tutoring rooms are in the form of chat rooms with instant messaging capabilities. Therefore, it is possible that children on this service will be contacted by an unknown person with harrowing intentions, even though they are only looking for help with homework. This major flaw in America Online's tutoring system emphasizes that an Internet-savvy child is not the only thing needed to create a safe Internet environment. Some level of supervision and the ability to access only child-friendly sites is also necessary.

Filtering software programs such as Cyber Patrol, Net Nanny and SmartFilter attempt to lessen the need for constant supervision. These programs can be installed onto a computer and serve to monitor, warn, or block access to web sites containing material which has been deemed inappropriate by the installer. Similar controls have been incorporated into some web browsers, including Internet Explorer and Netscape. These filtering software programs, however, require someone's active installation and their settings must be modified frequently, because standard program settings may restrict access to sites which are appropriate for children and may not block out every inappropriate destination. Also, these digital filtering techniques do not provide children with an isolated interface within which they can communicate with another person who is guaranteed to be a safe resource.

Some Internet Service Providers include filtering technology that does not require installation and provides a more isolated interface intended for use in schools. Examples of these products include Bascom's Access Management Engine (AME), Symantec's I-Gear and America Online's AOL@SCHOOL. AME provides a “default allow list,” selected by an Advisory Board, which allows a user to access only the sites specified in the list. I-Gear provides Internet content filtering software for both corporate and home use with features specific to Internet Service Providers (ISP), and allows filtering to occur at the specific location of the ISP. AOL@SCHOOL includes built in search filters and safety controls specific to each school's requirement. However, none of these products provide an interface which allows children to communicate directly with another child or an online mentor who can supervise them, where each person the child contacts is pre-approved and all contact is continuously screened and regulated for child safety by means of an off-site adult technician.

There are also several United States Patents which relate to tutoring and regulated communication designs. None of them accomplish as much as the present invention.

For example, Anupam et al. U.S. Pat. No. 5,862,330 discloses a technique for collaborative browsing on the Internet wherein two users exchange information with one user's browser connecting to the other user's browser and controlling the view of the other. However, Anupam does not disclose communication means outside of the function of web browsing of HTML documents. Thus, Anupam does not provide a means to communicate through messaging, sharing files and collaborating with other programs while each user is connected to the Internet, nor does Anupam provide safety means of an off-site adult technician who monitors a user's activity and guides the user on the world wide web.

Sonnenreich U.S. Pat. No. 5,974,446 discloses a distance learning system for communicating between server and clients. Sonnenreich teaches distant learning comprising online classes, text-based chat, email messaging and online presentations wherein a central virtual common room for system sharing comprises personal user identification information and user authentication. However, Sonnenreich does not provide one-to-one communication with dual shared access. Additionally, Sonnenreich does not disclose the idea of an offsite personal adult web browsing guide.

Bell et al. U.S. Pat. No. 6,014,134 discloses a network-based software tutoring application. Bell teaches of a virtual tutor which can be used as an interface for a user to receive answers to various questions wherein the response is generated by a database of information. Bell does not disclose tutoring or other communication means for person-to-person contact through the Internet.

Thus, there exists the need for an Internet environment that educates, supervises and offers a wealth of safe Internet resources for children. There exists a need for Internet communication means wherein children can browse the Internet with a personal off-site adult technical guide, or where children can communicate with each other on the Internet in a safe interface with the ability to interact in ways such as messaging, web browsing, file sharing and other media collaboration. The present invention makes this possible.

### SUMMARY OF THE INVENTION

The present invention provides an improved means and method of communication through the use of the Internet. This invention comprises an interface accessible by a user to log into a primary safe room with additional branch rooms, wherein each branch room comprises a unique activity. These activities may include, but are not limited to, games, arts and crafts, reading, homework help and a buddy connection. Each room is monitored by an adult technician to ensure proper behavior and child safety so that a child can participate in these rooms without the danger of viewing inappropriate material or receiving contact from a potentially dangerous adult disguised as a child. Furthermore, a buddy connection may comprise the linking of a user, typically a child, to an adult “buddy”/technician who serves as an aid to the user for accessing the world wide web in a capacity similar to an “electronic babysitter.” In this buddy connection, both the user and the “buddy”/technician browse the web together, with the technician being a monitor that will only allow viewing of appropriate material on the user's screen in accordance with the user's profile details such as age or other factors established by a child's parents. Furthermore, such a buddy connection may comprise a graphical interface and communication means wherein a child may communicate more comfortably on the world wide web without being required to type on a keyboard or speak on the phone. Additionally, a separate set of branch rooms may be provided for adults for rooms such as scheduling buddy appointments for their child, customer service and profile and customized setting information.

Therefore, it is an object of the present invention to provide interface means for a child to safely access information via the Internet.

It is also an object of the present invention to provide interface means for a child to safely communicate with other children through a variety of media forms.

Furthermore, it is an object of the present invention to provide an interface for a child to have safe access to a variety of individual activities such as games, art and reading.

Still Further, it is an object of the present invention to provide linking means wherein the user is guided and monitored by an off-site technician to explore the Internet.

Still Further, it is an object of the present invention to provide configuration means wherein a parent or guardian may set up appointments for their child to browse the Internet with a “buddy” technician, adjust personal settings as to what type of content their child may be given access to, and receive customer service and billing information regarding their account with the service.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 (FIG. 1) depicts a general organizational layout of the room structure of an embodiment according to the present invention.

FIGS. 2A-2C (FIGS. 2A-2C) depict screens which may be viewed by the user during the log on process.

FIGS. 3A-3D (FIGS. 3A-3D) depict screens which may be viewed by the user upon logging on to the home page.

FIGS. 4A-4C (FIGS. 4A-4C) depict screens which may be viewed by the user for entering a buddy link page.

FIG. 5 (FIG. 5) depicts a buddy communication screen of the present invention with art features.

FIG. 6 (FIG. 6) depicts buddy monitor screens.

FIG. 7 (FIG. 7) depicts a reading room screen.

FIG. 8 (FIG. 8) depicts an art activity room screen.

FIG. 9 (FIG. 9) depicts an art gallery page.

FIG. 10 (FIG. 10) depicts a homework help screen.

FIG. 11 (FIG. 11) depicts an adult's account information page.

FIG. 12 (FIG. 12) depicts an adult's news update page.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

The present invention could embody itself as a software program which can be installed in a user's Internet-accessible computer. This program may allow a parent to establish settings through the use of parental passwords or controls wherein a child may only access a safe interface. This safe interface is connected via Internet means to a host which is monitored by one or more off-site adult technicians. These adult technicians work to continuously screen and monitor a child's activities to function as a human filter to provide a safe Internet experience for the child.

Upon logging onto the interface, a child enters a safe room with the option to choose from a variety of activities. Each of these activities may be monitored by an adult technician as a filtering method or may be isolated from all Internet activity unrelated to the particular activity to provide a safe activity room for a child.

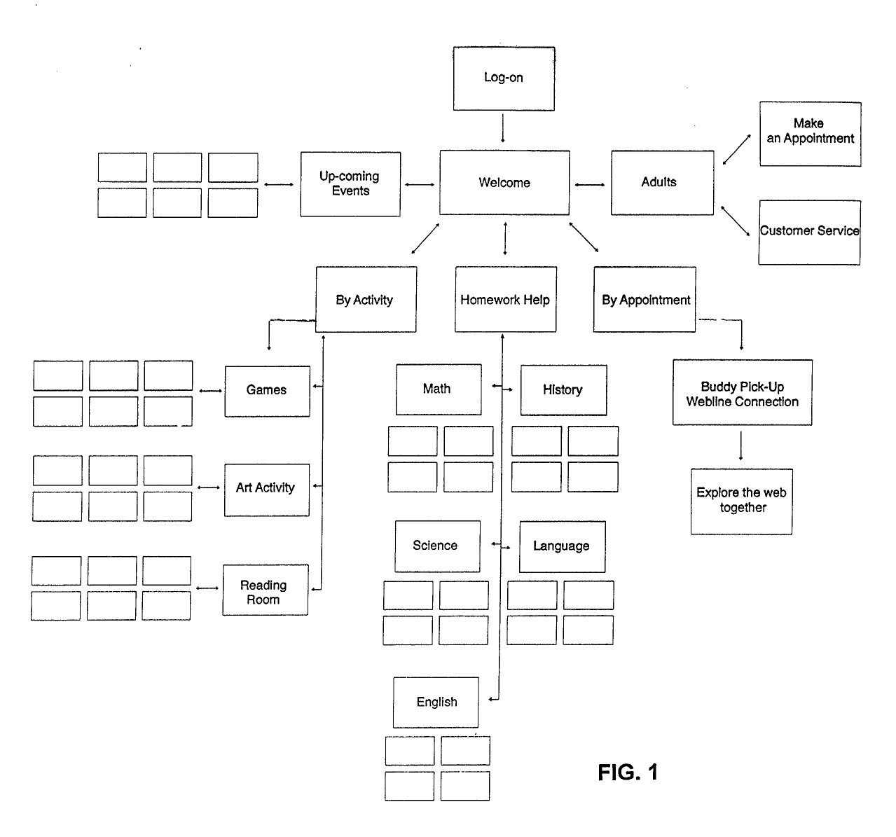

Referring first to FIG. 1, shown is a layout of possible menu selections upon first entering a common room after login to the safe interface of the present invention. The user views a “Welcome” page upon entering the common room and then can chose an Activity, Homework Help or an Appointment. The first two categories are further divided by specific types of activities and subjects for homework which may in turn be further divided.

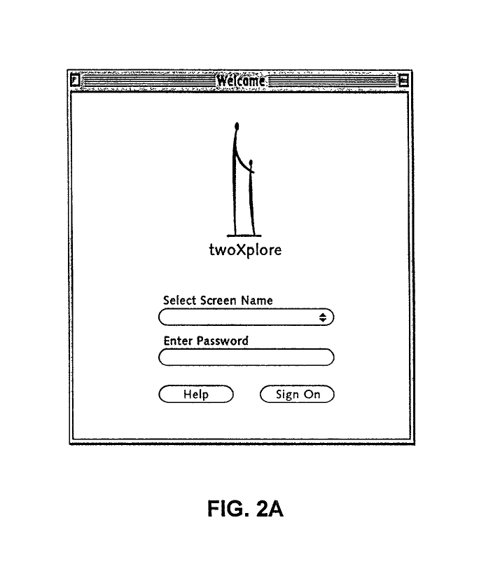

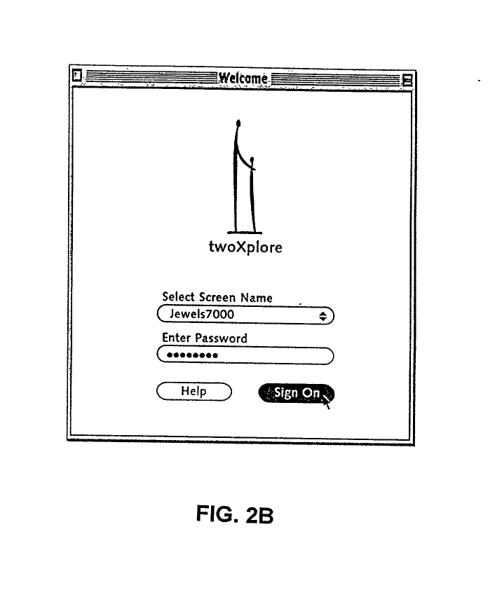

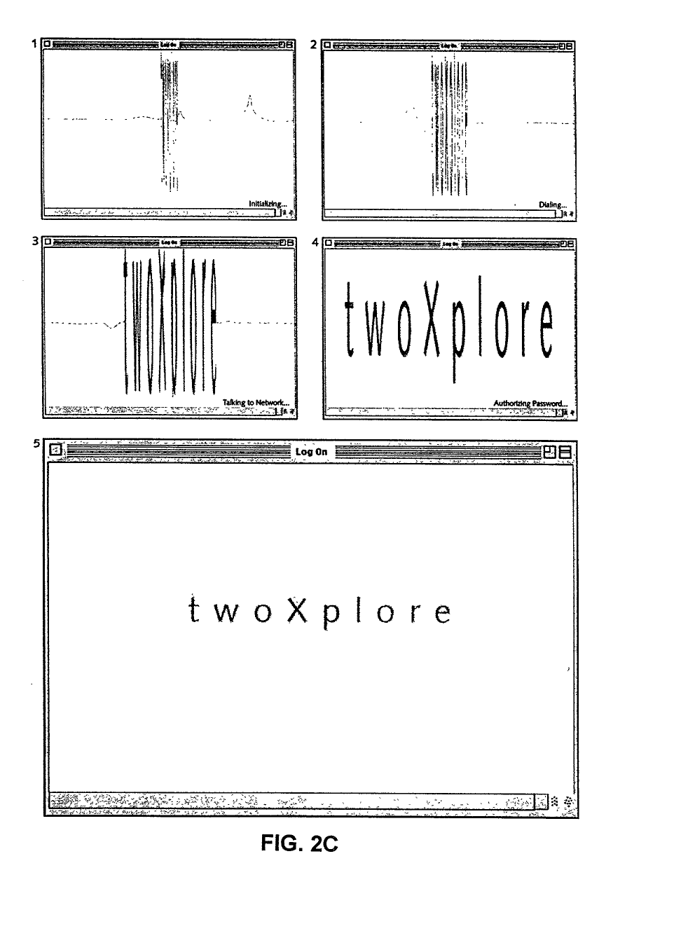

Referring next to FIGS. 2A-2C, shown in FIG. 2A is a log on menu which appears when a user chooses to log on to the interactive service of the present invention. The user must select his or her screen name and enter the correct password. Upon entering screen name and password, the user must click the Sign On button in FIG. 2B. A flash graphic such as the windows 1-5 in FIG. 2C may be displayed on the user's monitor to notify them of their connection status. A log on method such as this also provides the technician(s) with notification of who is logged on at any given time.

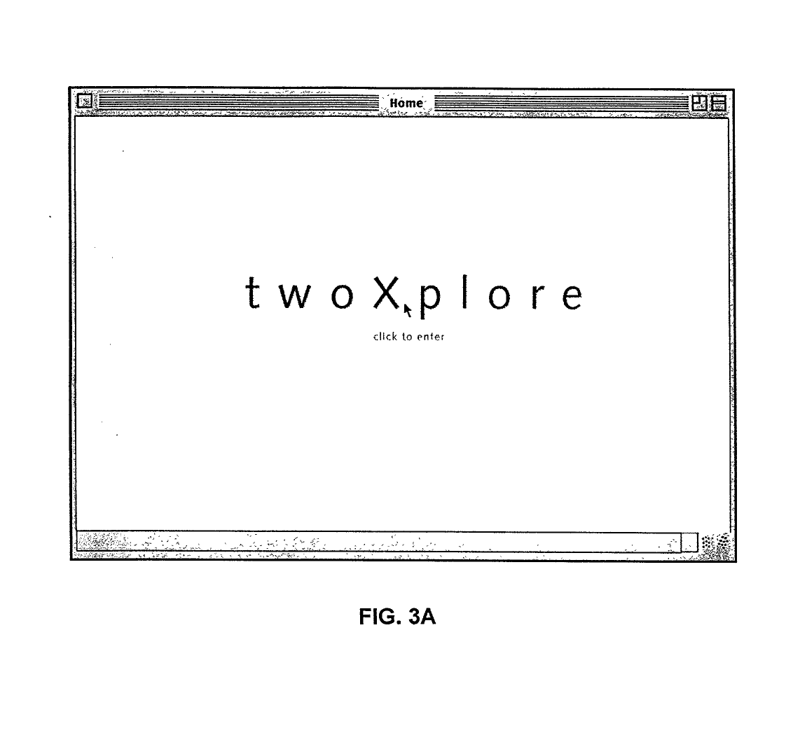

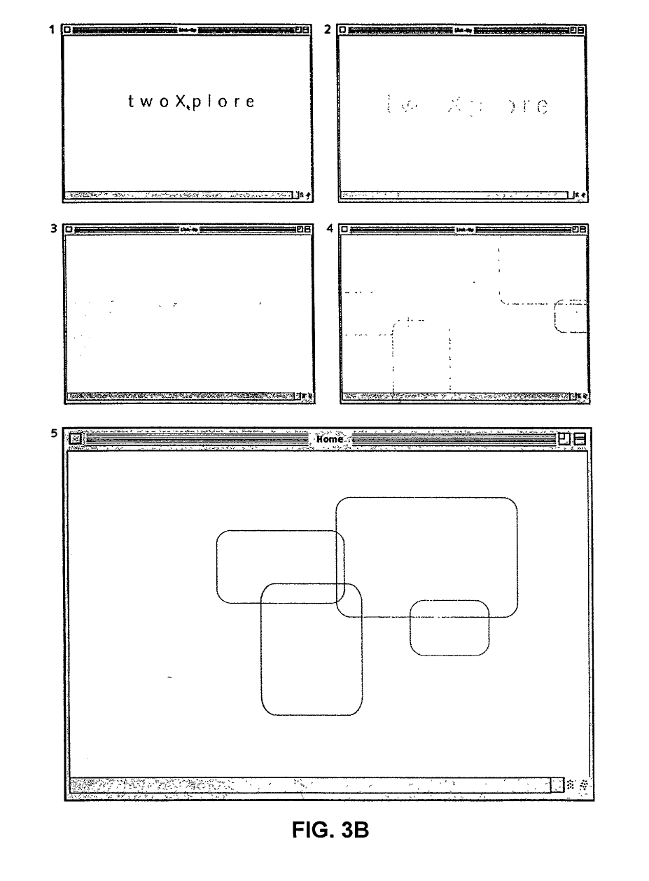

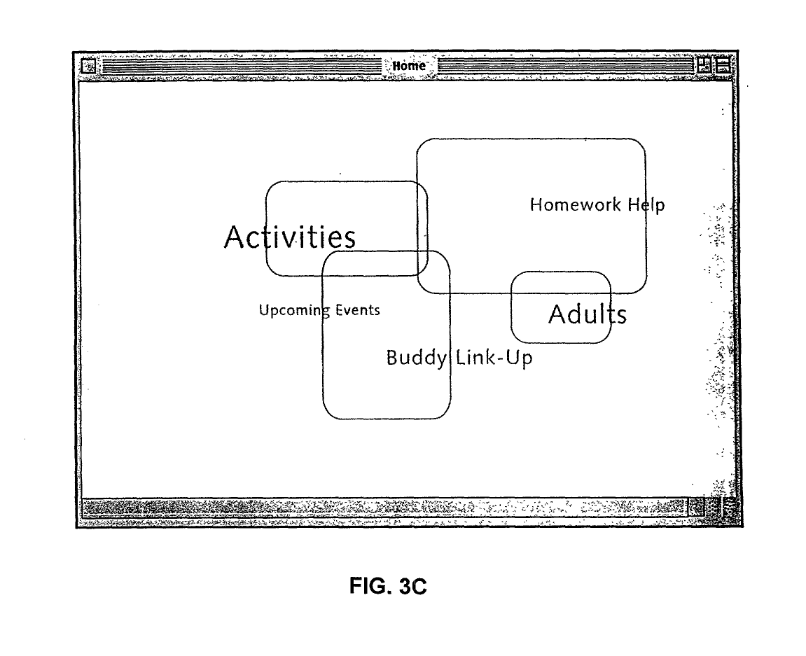

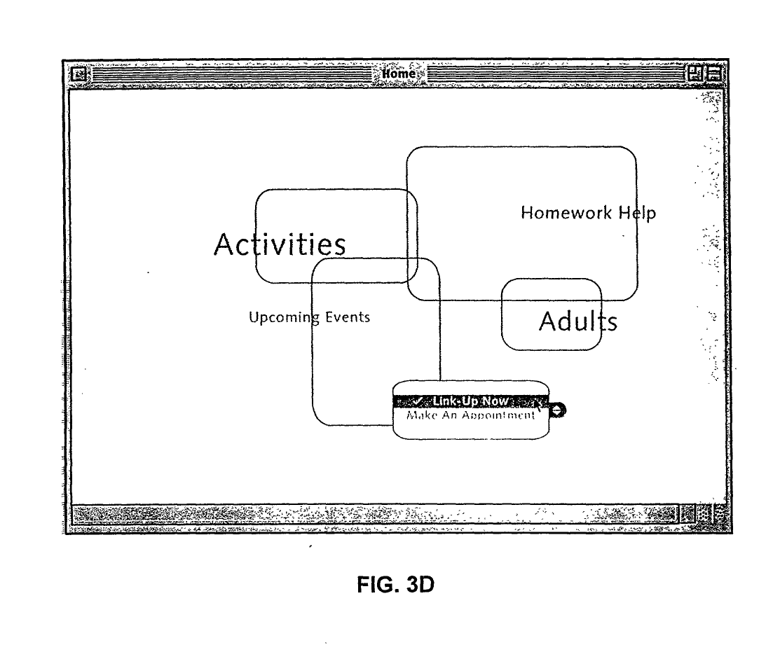

FIGS. 3A-3D shows screens viewed by the user upon successfully logging onto the service. FIG. 3A displays an entrance page which, upon clicking, leads to the opening of pages such as those shown in FIG. 3B wherein the service name in window 1 slowly fades while increasing in size in window 2 and then in window 3. In windows 4 and 5, elements from the home page start to appear and the home page slides into place as shown in FIG. 3C. Upon entering the home page, links to Activities, Homework Help, Upcoming Events, Buddy Link-Up and Adults appears. Upon choosing the Buddy Link-Up, the screen changes to FIG. 3D as a pull down menu appears wherein the user may chose from Link-Up Now or Make An Appointment options.

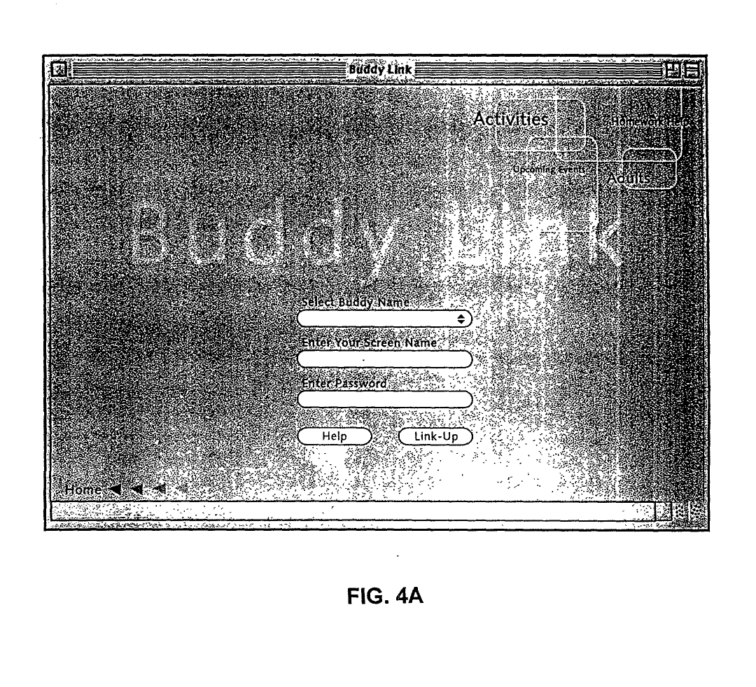

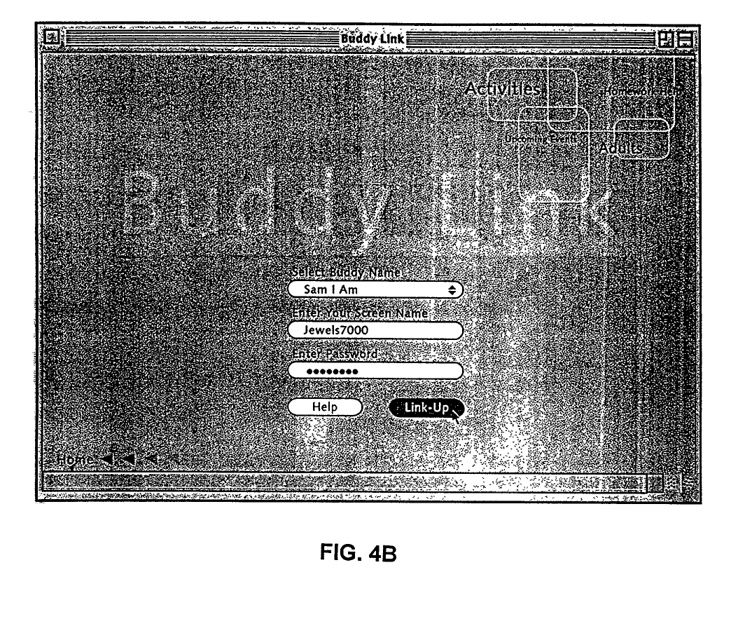

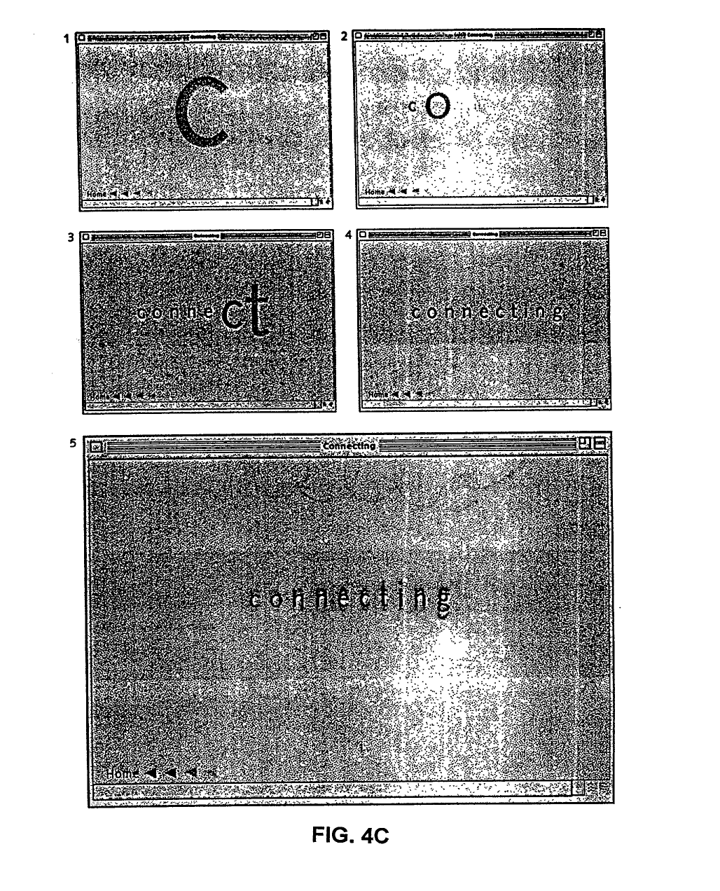

Referring next to FIGS. 4A-4C, shown are screens displayed during the Buddy-Link login process. Upon choosing the Link-Up Now option in FIG. 3D, the home page retreats to the upper right hand corner for navigation control while at the same time the service company name transforms into a different color and changes to the words “Buddy Link” as shown in FIG. 4A. The user then enters a Buddy Name to link with, the user's own Screen Name and password and then selects the Link-Up button in FIG. 4B. While the connection is being made with the selected buddy, a flash graphic appears which informs the user that the connection is taking place. Examples of individual frames of this flash graphic are shown in windows 1-5 in FIG. 4C.

Upon successful log on to the Buddy Link, a child is able to browse the Internet for educational or entertainment purposes wherein each page a child chooses to browse is first screened by the adult technician/buddy. In this fashion, all content viewed by a child may be deemed safe by an adult technician/buddy. Additionally, this adult technician/buddy can assist the child in their Internet experience by recommending various web sites for certain material of interest to the child as well as answer questions the child may have about particular technical issues or general material related to content viewed on the Internet. An additional window for child/buddy text chat may be provided to assist in child/buddy communication and/or communication may be enhanced through the use of microphone, speakers, and any related audio software.

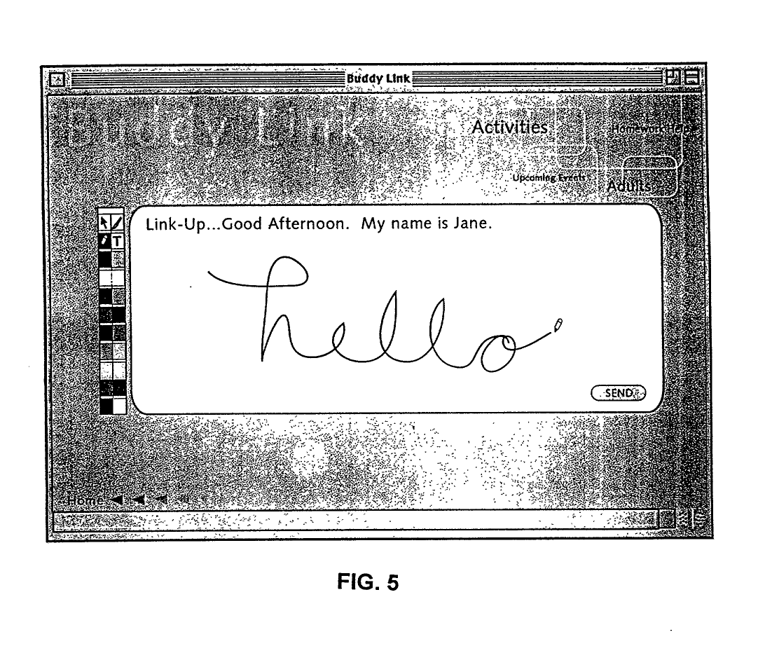

During the buddy link connection, the user can communicate with the buddy by either typing or drawing or via telephone. Additional windows may be opened for viewing other sites, such as sites within the service's web site listing or other web sites. FIG. 5 is an example of one such communication window, wherein the user may use graphical means of communicating with their buddy.

The service of the present invention may also be used for the exchanging of various files wherein the user may receive (download) or send (upload) files from the service. Such files may include various art templates, for example, from the art activities room. By using these art templates, the user may be provided with a modern day or online coloring book.

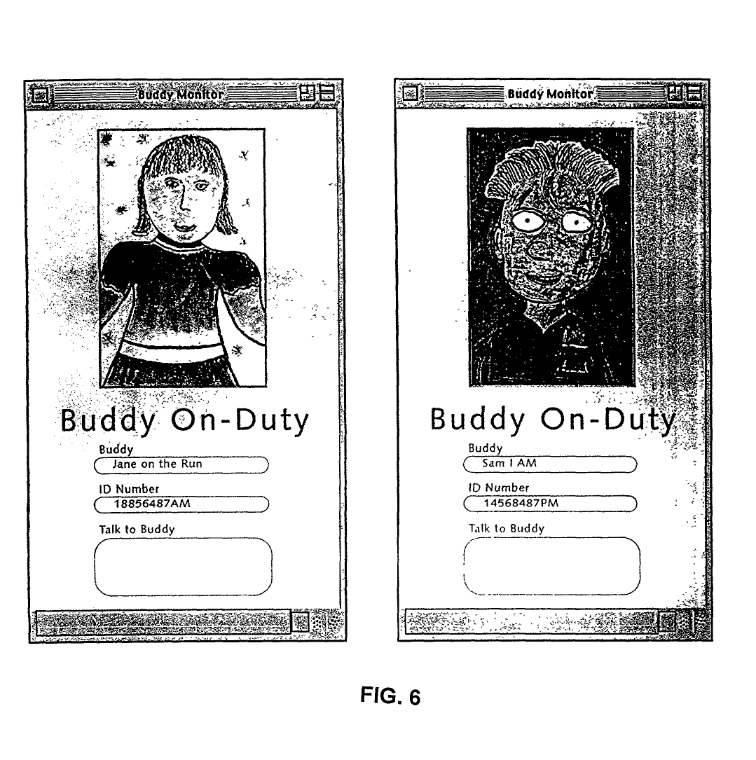

Referring next to FIG. 6, shown are Buddy Monitors. These windows inform a user whom the buddy/monitor on-duty is for the particular room the user is in. When the user enters another room the buddy information will change. A “buddy” is assigned to each room to answer questions the user/child may have and to monitor any information exchanges. Such buddy monitoring provides the safety feature of looking out for the welfare of the users/children on the site.

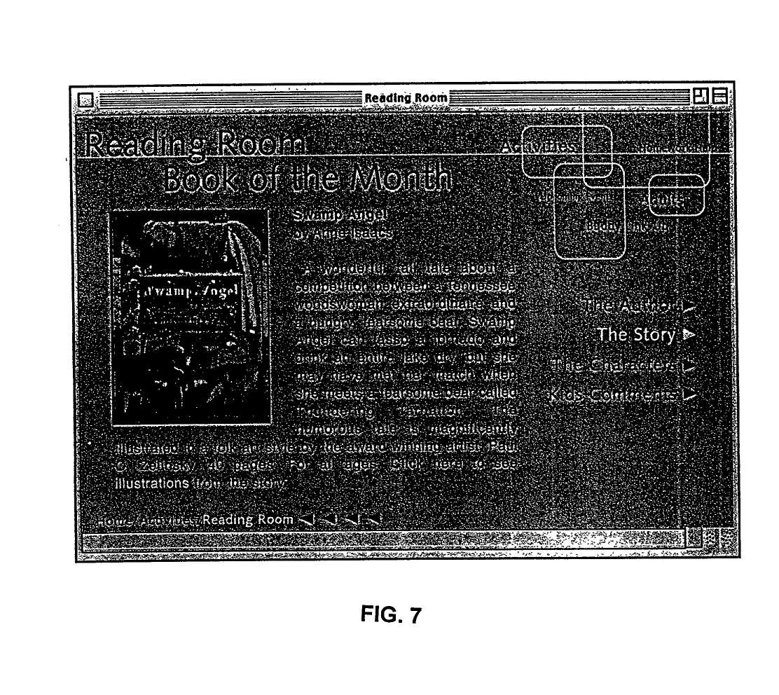

FIG. 7 shows a Reading Room Page. Such a page features a book of the month, wherein a child can obtain information about the story, the author, and what other users/children thought of the book. Approximately once a week a buddy links to this room to discuss the book. From this page, the child can link to past books of the month.

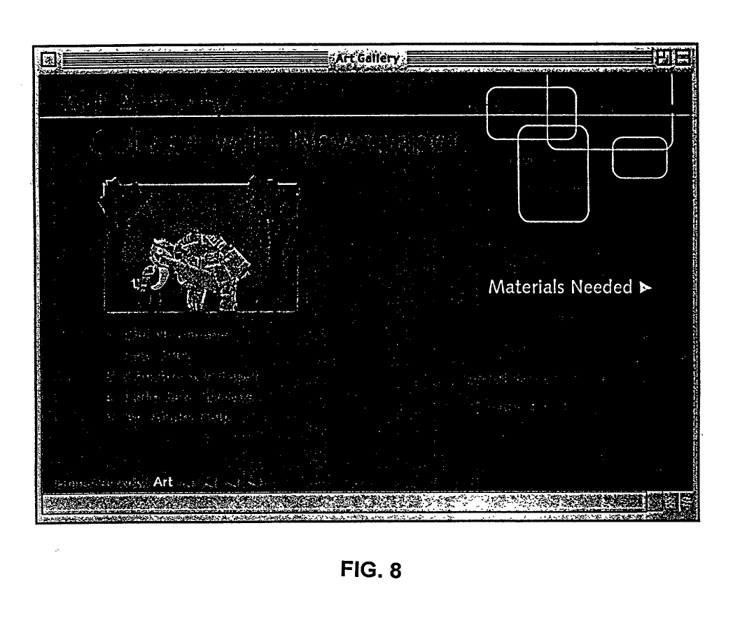

FIG. 8 shows an Art Activity Page. This page gives directions on how to complete a specific art project. Once per week, at a specific time, a buddy will log on to this page and perform the art activity, step by step, with any users/children logged on at the time.

A screen within this Art Activity Page or other pages, and in particular the Buddy Page, may be configured with one or more software programs, including the commonly available Microsoft Paint program, supplied by either a user's computer or the host service (twoxplore) to allow a user to communicate graphically with another user or an adult guide. Additionally, a user may be able to save their pages as files on their own computer and may also be able to share these files or other files with other users, with the approval of an approved buddy or adult technical guide.

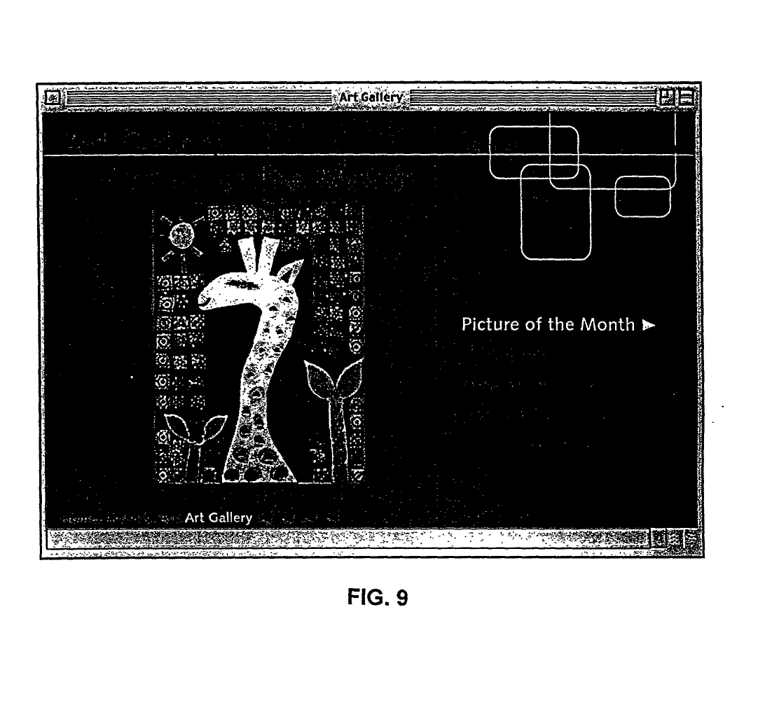

FIG. 9 shows an Art Gallery Page. One feature found on this page is the Picture of the Month, wherein a user/child can view other user's art work, vote on a favorite for the next month, submit their own work and transfer files for sharing with a friend.

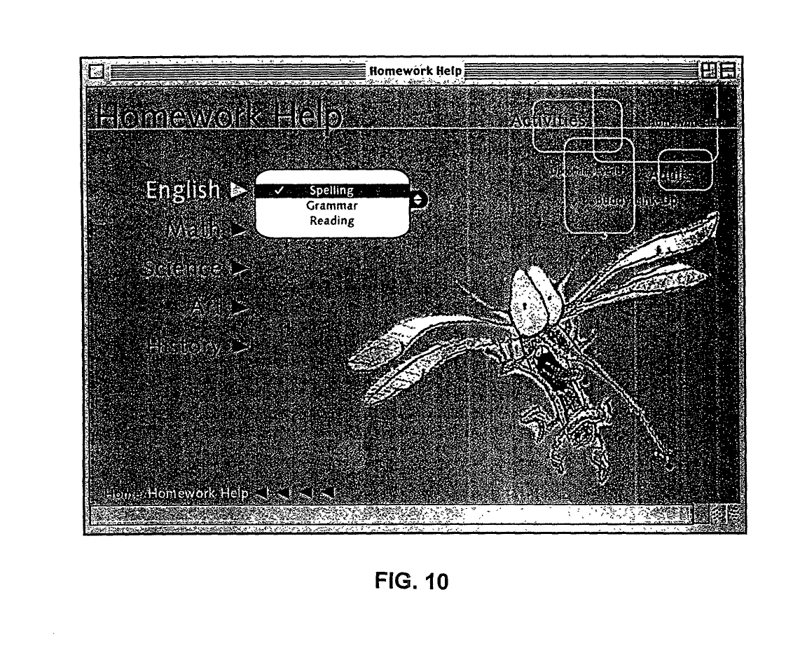

FIG. 10 shows a Homework Help Page which provides links to homework help in a specific subject such as English, Math, Science, Art, History, etc. The links provide children with resources to help them solve their homework problems or assist in other child educational activities.

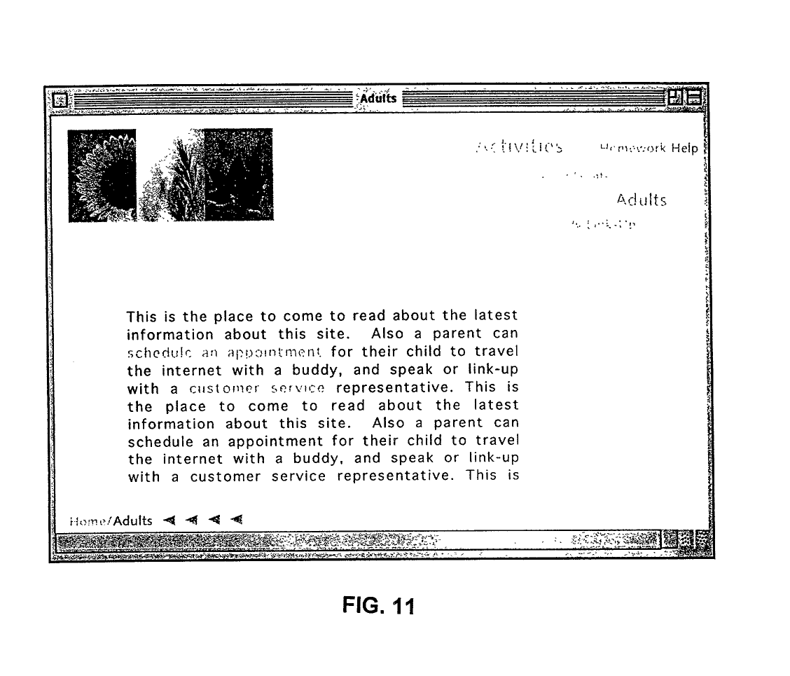

FIG. 11 shows an Adults Page used to inform parents of the tools provided by the service company, in this case twoxplore. Parents can sign up for user services, make an appointment and link up with customer service through this page. The top left hand corner of the page contains rollovers, one side imagery, one side type, linking an adult to the features or news updates at the time.

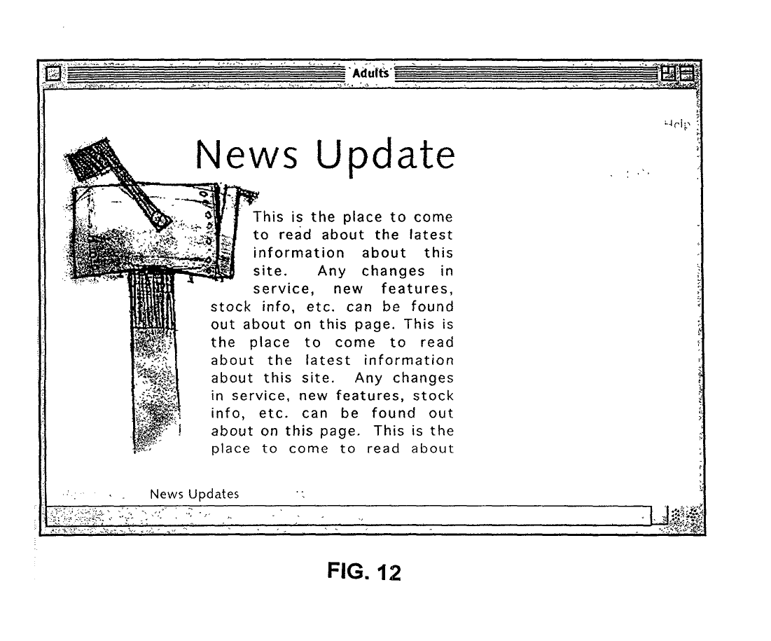

FIG. 12 shows a News Update Page which informs parents of the latest changes, events, etc. concerning the service company, in this case twoxplore.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. A method of communication for a plurality of users wherein activity of said users is regulated by a remote system, said regulation comprising:
setting means, wherein an entity provides specific formats of acceptable material to be accessed by a plurality of users;
monitoring means comprising the transferring of information requested to be accessed by said plurality of users, further comprised of comparison means wherein said information requested to be accessed is coupled with setting means, yielding user access only to material deemed appropriate by predetermined settings of said remote system.

2. A method in accordance with claim 1, wherein said communication comprises access to the Internet coupled to applications related to the Internet.

3. A method in accordance with claim 1, wherein said plurality of users are children.

4. A method in accordance with claim 1, wherein said regulation comprises the analysis of data requested to be accessed by one of said plurality of users, said analysis comprising the determination of appropriateness of material by said remote system for a plurality of child age groups.

5. A method in accordance with claim 4, wherein said remote system comprises an adult technician communicating from a remote location.

6. A method in accordance with claim 5, wherein said predetermined settings are adjusted by an adult for a particular child wherein an interface is provided for the quick adjustment of said settings.

7. A method in accordance with claim 6, wherein a password is required to make changes to said settings.

8. A method in accordance with claim 1, wherein a link is provided for communication between one user and one technical remote guide, said link comprises an interface, said interface allows real-time communication between said user and said technical remote guide.
